(19) United States
(12) Patent Application Publication
(10) Pub. No.: US 2005/0118091 A1
(43) Pub. Date: Jun. 2, 2005

(54) Hydrogen storage utilizing carbon nanotube materials

(76) Inventors: Alan Charles Cooper, Macungie, PA (US); Hansong Cheng, Allentown, PA (US); Guido Peter Pez, Allentown, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 10/724,848

(22) Filed: Dec. 1, 2003

(51) Int. Cl. D01F 9/12; C01B 3/02

(52) U.S. Cl. 423/447.1; 423/447.2; 423/648.1

(57) ABSTRACT

A material for the storage of hydrogen is provided comprising single wall carbon nanotubes (SWNT), wherein the majority of the diameters of the single wall carbon nanotubes of the assembly range from 0.4 to 1.0 nanometers (nm), and the average length is less than or equal to 1000 nm, or the diameters of the single wall carbon nanotubes of the assembly range from 0.4 to 1.0 nanometers (nm), and the heat (−ΔH) of hydrogen adsorption of the material is within the range from 4 kcal/mole H₂ to 8 kcal/mole H₂. Processes for the storage and release of hydrogen using the materials are disclosed.

### BACKGROUND OF THE INVENTION

Hydrogen is a widely used commodity in the chemical and petroleum processing industries. Typically it is manufactured by a reforming of natural gas and is delivered to the users' sites by pipeline, as liquid H₂ or as a highly compressed gas in cylinders. The transport of hydrogen as a cryogenic liquid or as compressed gas are capital and energy-intensive processes that result in a significantly higher cost for the delivered gas. Therefore, there has been a large research effort directed at finding lower cost alternatives, principally on developing materials that could effectively “capture” hydrogen at or near ambient conditions and release the gas as desired, at the point of use. Recently such efforts have been greatly stimulated by the emerging technology of H₂-powered fuel cells which for mobile systems ideally require a safe and cost-effective means for an on-board storage of hydrogen.

Most of the research towards ways to “contain” hydrogen has focused on the reversible chemical reaction and absorption of H₂ by various metals and metal alloys to form metal hydrides. Representative systems are LaNi₅, FeTi and various magnesium-rich alloys, such as Mg₂Ni and Mg₂Fe. In general, the hydride-forming metals/alloys that demonstrate favorable thermodynamic properties display a poor gravimetric H₂ capacity, whereas hydride-forming metals/alloys with a relatively high H₂ capacity generally have unfavorable thermodynamic properties, their regeneration requires impractically high temperatures.

The sorption and storage of hydrogen by various new structural forms of carbon, inherently light weight materials, has recently gained widespread attention. It had been known for some time that high-surface area activated carbons and certain alkali-metal graphite intercalation compounds will reversibly sorb considerable quantities of hydrogen, but only at cryogenic temperatures. Such systems therefore do not offer practical or economic advantages over the use of compressed or liquified hydrogen. The recent discovery of singlewalled carbon nanotubes (SWNT), a new class of carbon materials, has opened the exploration of these materials for the separation and adsorption of gases. SWNT are composed of single graphene sheets (one layer of graphite), rolled into a seamless cylinder with a diameter that generally ranges from 0.7-2.0 nm. The lengths of SWNT produced by known synthesis methods are typically greater than 1000 nm, giving aspect ratios (length/diameter) of >>1000. The wrapping of single graphene sheets to form cylinders can be performed at a number of angles relative to the hexagonal graphene sheet lattice, producing SWNT with various chiralities. Using chiral (n,m) indices, the SWNT are grouped into three categories-armchair (n=m=integer), zigzag (n=integer, m=0), and chiral (n and m are unequal integers). As produced SWNT materials are usually not single nanotubes but come as bundles or packed arrays of nanotubes or “ropes” with a very high aspect ratio.

Dillon et al in Nature 1997, 386, 379 report on an unprecedented reversible sorption of hydrogen at ambient temperatures by a carbon soot material. An estimated 5-10 wt. % H₂ capacity is ascribed to the presence of 0.1 to 0.2 wt % of SWNT in the carbon sample. Y. Ye et al in Appl. Phys. Lett. 1999, 74, 2307, working with a relatively pure SWNT material recorded a very large (ca. 8 wt %) reversible hydrogen uptake at cryogenic temperatures but did not observe the claimed high H₂ storage capacity at ambient conditions. Attempts by Dillon et alto enhance the hydrogen capacity of SWNT by cutting the nanotubes with a high power sonication probe led to materials, combinations of nanotubes and metal from the probe, displaying a reportedly high (˜7 wt. %) hydrogen capacity. (Mat. Res. Soc. Symp. Proc., 2001, 633, Q9.11). It's suggested in this report that the presence of hydrogen-reactive metal particles is critically necessary for a substantial uptake of hydrogen at ambient temperature and low pressures of hydrogen. In U.S. Pat. No. 6,596,055 by A. C. Cooper et al and in the US Application 2002/0146624 A1 by Goto et al are taught methods for the storage of hydrogen utilizing a combination of H₂-reactive metals and various forms of carbon including nanotube compositions.

L. Chang and H. M. Cheng report (J. Mater. Sci. Technol. 2002, 18(2), 124) a substantial uptake of hydrogen (4.3 wt. %) at ambient temperature and high pressure (ca. 1800 psia) using relatively large diameter (˜1.8 nm) SWNT of ˜50% purity. In contrast, G. Tibbetts et al report (Carbon 2001, 39, 2291) that SWNT of a similar diameter range and purity adsorb less than 0.05 wt % H₂ under similar conditions of temperature and pressure.

In WO 01/53199 A2, Dillon et al describe methods for processing SWNT to prepare SWNT “superbundles” (arrays or “ropes” of nanotubes) for use as hydrogen storage media, but no H₂ uptake data is provided. In application WO 02/083556 A1, B. K. Pradhan et al teach on methods for purifying and opening the ends of SWNT materials; their claim of a use of these materials for hydrogen storage is however, only based on H₂ uptake data at cryogenic temperatures where it's known that even common activated carbons are effective.

Rodriquez et al in U.S. Pat. No. 5,653,951 and in U.S. Pat. No. 6,159,538 claim a storage of hydrogen by chemisorption of hydrogen in “layered carbon nanostructures” which at high pressures (>1000 psia H₂) and ambient temperatures sorb very large (up to 43 wt. %) quantities of hydrogen. The “layered nanostructures” are characterized as materials having interstices between 0.335 (the interlayer spacing in graphite) and 0.67 nm, cited examples for which are carbon nanofibers and carbon nanotubes. All of the H₂ uptake data was recorded using graphite nanofibers, no such data for carbon nanotubes was reported. The extraordinary H₂ capacity with carbon fibers claims of Rodriquez et al have been disputed by investigators from several other laboratories (For example see C. Ahn et al in Appl. Phys. Lett. 1998, 73, 3378 and Q. Wang, et al in J. Phys. Chem. B 1999, 103, 277).

The above cited reference of Dillon et al., that of M. Shirashi et al in Chem Phys. Lett 2003, 367, 633 and P. Sudan et al in Carbon 2003, 41, 2377 cite a heat of adsorption (−ΔH_{ads}) of the order of about 4.5 kcal/mole H₂, as measured by a temperature desorption (TPD) technique. As noted by Dillon et al this heat is significantly larger than the ˜1 kcal/mole for H₂ on graphite and is said to indicate a population at room temperature by hydrogen of “structurally unique” sites in the SWNT containing soot. Nevertheless, even at this level of heat of adsorption of H₂ (as measured by TPD) the hydrogen gravimetric capacity is tiny: ˜0.3 wt % at ˜90 atm for a relatively pure SWNT material, as reported in the above M. Shirashi et al reference.

There are a number of publications on computational modeling of H₂ adsorption on SWNT materials, using various levels of technical sophistication in the modeling methods. For a review see: A. C. Dillon and M. J. Heben, Appl. Phys. A, 72-14 (2001). Of particular relevance to this disclosure are studies using high level, and hence potentially more precise ab initio quantum mechanics calculations, that have led to a prediction from first principles of an energy (−ΔE) for H₂ adsorption on SWNT materials: Examples are the static many-body electron correlation calculations (at the MP2 level) of Okamoto and Miyamato (J. Phys. Chem. B, 2001, 105, 3470) who showed that the energy of H₂ adsorption on curved carbon surfaces is several times greater vis-á-vis planar graphene (single sheet graphite) structures. This favorable curvature effect of carbon structures is also evident in the quantum mechanical-molecular dynamics studies by H. Cheng et al, (J. Am. Chem. Soc., 2001, 123, 5845). A dynamic interaction of H₂ molecules with the curved interior and exterior surfaces of nanotubes in SWNT arrays leads to predicted H₂ adsorption energies that are consistent with the above experimental data heat of adsorption from Dillon et al., Shirashi et al, and Sudan et al.

While it appears that there is some “special” affinity of SWNT materials for hydrogen, the literature reports on achievable H₂ capacities are clearly a matter of controversy (see also additionally M. Hirscher et al, J. Nanosci. Nanotech, 2003, 3, 3). There is a need in the art for a way to to practically store hydrogen.

### BRIEF SUMMARY OF THE INVENTION

This invention provides a material for the storage of hydrogen comprising an assembly of single wall carbon nanotubes (SWNT), wherein the majority of the diameters of the single wall carbon nanotubes of the assembly range from 0.4 to 1.0 nanometers (nm), and the average length of the single wall carbon nanotubes is less than or equal to 1000 nm, or less than or equal to 500 nm, or less than or equal to 200 nm. This invention further provides a material for the storage of hydrogen comprising an assembly of single wall carbon nanotubes, wherein the majority of the diameters of the individual nanotubes of the assembly range from 0.4 to 0.8 nanometers (nm), and the average length of the single wall carbon nanotubes is less than or equal to 1000 nm, or less than or equal to 500 nm, or less than or equal to 200 nm.

This invention further provides a material for the storage of hydrogen comprising an assembly of single wall carbon nanotubes (SWNT), wherein the majority of the diameters of the single wall carbon nanotubes of the assembly range from 0.4 to 1.0 nanometers (nm), and the heat (−ΔH) of hydrogen adsorption of the material is within the range from 4 kcal/mole H₂ to 8 kcal/mole H₂, or within the range from 5 kcal/mole H₂ to 7.5 kcal/mole H₂, or within the range from 5.3 kcal/mole H₂ to 7 kcal/mole H₂, and additionally the average length of the single wall carbon nanotubes may be less than or equal to 1000 nm, or less than or equal to 500 nm, or less than or equal to 200 nm. This invention provides a material for the storage of hydrogen comprising an assembly of equal to 1000 nm, or less than or equal to 500 nm, or less than or equal to 200 nm. This invention provides a material for the storage of hydrogen comprising an assembly of single wall carbon nanotubes, wherein the majority of the diameters of the individual nanotubes of the assembly range from about 0.4 to 0.8 nanometers (nm), and the heat (−ΔH) of hydrogen adsorption of the material is within the range from 4 kcal/mole H₂ to 8 kcal/mole H₂, or within the range from 5 kcal/mole H₂ to 7.5 kcal/mole H₂, or within the range from 5.3 kcal/mole H₂ to 7 kcal/mole H₂, and additionally the average length of the single wall carbon nanotubes may be less than or equal to 1000 nm, or less than or equal to 500 nm, or less than or equal to 200 nm.

The present invention provides materials for hydrogen storage comprising single wall carbon nanotubes (SWNT) having physical dimensions that are effective for containment or storage of hydrogen by an adsorption of the gas as H₂ molecules within the structure of the materials. In one embodiment, there will be no hydrogen-reactive metal or metal alloys added to the single wall carbon nanotubes used in the invention during the method of making them, and in another embodiment the hydrogen-reactive metal or metal alloys that may be present in the single wall carbon nanotubes as the result of the methods of making them will be partially to completely removed in one or more purification steps.

This invention further provides a process for the storage and release of hydrogen in a vessel comprising single wall carbon nanotubes wherein the majority of diameters of the single wall carbon nanotubes range from 0.4 to 1.0 nm, and the average length of the single wall carbon nanotubes is less than or equal to 1000 nm, or wherein the majority of diameters of the single wall carbon nanotubes range from 0.4 to 1.0 nm and the heat (−ΔH) of hydrogen adsorption of the material is within the range from 4 kcal/mole H₂ to 8 kcal/mole H₂, and the wherein said process is selected from the group consisting of: pressure swing adsorption, temperature swing adsorption or pressure and temperature swing adsorption.

This invention further provides a process for the storage and release of hydrogen comprising the steps of:
providing a vessel comprising single wall carbon nanotubes wherein the majority of the diameters of the single wall carbon nanotubes of the assembly range from 0.4 to 1.0 nm, and the average length of the single wall carbon nanotubes is less than or equal to 1000 nm, or wherein the majority of the diameters of the single wall carbon nanotubes of the assembly range from 0.4 to 1.0 nm and the heat (−ΔH) of hydrogen adsorption of the material is within the range from 4 kcal/mole H₂ to 8 kcal/mole H₂; introducing hydrogen into the vessel while increasing the pressure to a sorption pressure whereby the hydrogen is absorbed by the single wall carbon nanotubes; and discharging the hydrogen from the vessel by decreasing the pressure from the sorption pressure to a desorption pressure whereby the hydrogen is desorbed by the single wall carbon nanotubes.

### BRIEF DESCRIPTION OF SEVERAL VIEWS OF THE DRAWINGS

FIG. 1 is a cross-sectional illustration of the adsorption sites within a bundle of single wall carbon nanotubes.

FIG. 2 is an overlay graph of hydrogen isotherms of a sample (Example 1) of small-diameter, low aspect ratio (short) single wall carbon nanotubes.

FIG. 3 is an overlay graph of hydrogen isotherms of a sample (Example 2) of small-diameter, high aspect ratio (long) single wall carbon nanotubes.

FIG. 4 is an overlay graph of hydrogen isotherms of a sample (Example 3) of large-diameter, high aspect ratio (long) single wall carbon nanotubes produced by arc-discharge.

FIG. 5 is an overlay graph of hydrogen isotherms of a sample (Example 4) of large-diameter, high aspect ratio (long) single wall carbon nanotubes produced by supported chemical vapor deposition.

FIG. 6 is an overlay graph of the isoteric heats of adsorption of hydrogen as a function of loading or coverage (mmol H₂/gram) for four single wall carbon nanotube samples from Examples 1-4.

FIG. 7 is an overlay graph of the calculated volumetric hydrogen storage density of an empty tank and a tank of equal volume containing the single wall carbon nanotubes of Example 1 with a packing density of 1 g/cc.

FIG. 8 is a graph of a combined pressure-swing/temperature-swing process for hydrogen storage, with the assumption of a Langmuir isotherm with a ΔH of −5.9 kcal/mole H₂ and ΔS=−25 cal/mole K.

FIG. 9 is an overlay graph of a combined pressure-swing/temperature-swing process for hydrogen storage, with heats of H₂ adsorption of −ΔH=7 kcal/mole H₂ and of −ΔH=5 kcal/mole H₂.

### DETAILED DESCRIPTION OF THE INVENTION

The present invention relates to materials and processes for a containment and storage of hydrogen by adsorption. The materials comprise single wall carbon nanotubes (SWNT) where the majority of the individual nanotubes have a diameter within a specified range. The SWNT may be arranged in arrays or bundles or ropes (these terms may be used interchangeably herein), and a plurality of bundles may be packed together in an assembly useful as the material of this invention.

The bundles of single wall carbon nanotubes comprise at least 3, or at least 7, or at least 10, or at least 50, or at least 100 single wall carbon nanotubes. There is no limit to the number of single wall carbon nanotubes in a bundle, except that the bundles must fit in the vessel to be used for hydrogen storage. Presently, typically bundles are made comprising less than 1,000 single wall carbon nanotubes, and the assemblies comprise a plurality of bundles.

The material of this invention may be referred to as “SWNT materials” or “SWNT adsorbent” or “SWNT”. It is understood that the use of “SWNT materials”, “SWNT adsorbent” or “SWNT” means single wall carbon nanotubes that may comprise impurities, e.g. non-single wall carbon nanotubes, and metals, and cutting aid materials, and other components as described below.

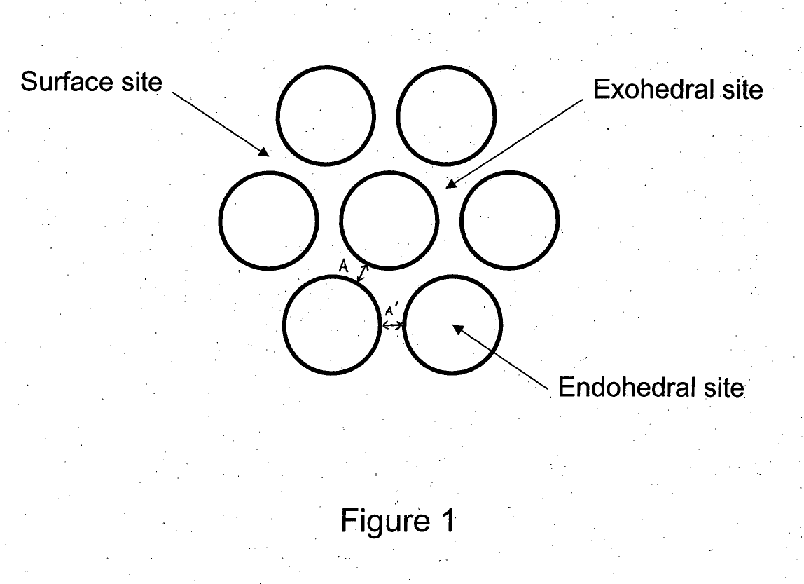

FIG. 1 shows a cross-section of a bundle consisting of 7 single wall carbon nanotubes having the preferred hexagonal arrangement. There may be discontinuities in the hexagonal arrangement of the single wall carbon nanotubes in the bundle due to defects and kinks in the nanotubes and due to the bundling of single wall carbon nanotubes of differing diameters. As shown in FIG. 1, the bundle of single wall carbon nanotubes have pores or spaces within the nanotubes, on the surface of the nanotubes, and in the interstices between the nanotubes for accommodating the adsorbed H₂ molecules. To maximize the storage of hydrogen, the H₂ molecules will require access to the internal (endohedral) and interstitial (exohedral) nanotube sites. In a geometrically “perfect” array of nanotubes as shown in FIG. 1, these sites should be relatively accessible, but in actual practice there may be kinks, blockages or discontinuities along the endohedral and exohedral channels, the pathways for adsorptive H₂ diffusion. Therefore, in one embodiment to provide access to the internal and interstitial sites and for optimum storage of hydrogen it is desirable to utilize single wall carbon nanotubes arrays where the average length is less than or equal to 1000 nm, or less than or equal to 500 nm, or less than or equal to 200 nm.

The storage space for hydrogen is also a function of the single wall carbon nanotubes' diameter. The majority of the single wall carbon nanotubes' diameters should range from between from 0.4 to 1.0 nm, or from 0.4 to 0.8 nm. The single wall carbon nanotubes in the bundle or bundles are closely packed. It is preferred that the average inter-tube spacing within the bundle, or within the material, that is, the average distance between the nanotube walls of the single wall carbon nanotubes where the single wall carbon nanotubes are closest to eachother as indicated by the lines A, and A′ in FIG. 1 is between from 0.3 to 0.4 nm. Assemblies comprising bundles of single wall carbon nanotubes having these specified characteristics provide maximized storage capacity for hydrogen.

SWNT are produced by a variety of methods, each individual method producing SWNT of varying purity and physical parameters (nanotube diameter, nanotube length). Two common production methods include the carbon-arc method (C. Journet et al, Nature 1997, 388, 756) and the laser-ablation method (A. Thess et al, Science 1996, 273, 483), both of which produce SWNT by the evaporation of carbon at extremely high temperatures in the presence of transition metal catalyst(s). More recently, the use of chemical vapor deposition (CVD) to produce SWNT has been reported. CVD production of SWNT can be performed using transition metal catalysts supported on inert support materials (B. Zheng et al, Appl. Phys. A 2002, 74, 345) and catalysts formed from the vapor phase by thermal decomposition of catalyst precursors (P. Nikolaev et al, Chem. Phys. Lett. 1999, 313, 91). Generally, CVD production methods generally produce SWNT with a larger distribution of diameters. However, certain CVD methods produce SWNT materials with a small diameter distribution where the majority of the nanotubes have a diameter <0.85 nm (S. Bachilo et al, J. Am. Chem. Soc. 2003, 125, 11186). SWNT with a narrow diameter distribution from 0.62 nm to 0.92 nm can be produced by the disproportionation of carbon monoxide on Co/Mo catalyst dispersed on high-surface-area silica. The SWNT are grown in a fluidized bed reactor on the pre-reduced catalyst under a flow of pure CO at a pressure of 5 atmospheres. The silica and metal can be removed by subsequent washing with aqueous hydrofluoric acid. SWNT with a uniform diameter of 0.4 nm can be produced by the pyrolysis of organic precursors in porous zeolite materials (N. Wang et al, Nature 2000, 408, 50 and N. Wang et al, Chem. Phys. Lett. 2001, 339, 47). Wang et al have produced 0.4 nm SWNT by the pyrolysis of tripropylamine molecules in the channels of porous aluminophosphate zeolite single crystals. The SWNT can be isolated by dissolving the zeolite host framework with hydrofluoric acid and/or base.

The methods to produce SWNT may make SWNT materials of this invention, but typically the methods to produce SWNT produce SWNT with impurities present in the SWNT materials. The impurities may be removed from the SWNT materials prior to use. SWNT impurities generally include residual metal catalyst particles and non-SWNT carbons (amorphous carbon, graphite, fullerenes) and may contain other components. Common purification methods to remove metal and selectively etch non-SWNT carbon impurities from the product include: acid leaching, gas phase oxidation, microwave heating, field-flow fractionation, size exclusion chromatography, surfactant/water suspension, and soluble polymer extraction. In the acid leaching method, the SWNT material is washed with concentrated or diluted acids in order to etch the metal catalyst impurities from the carbon. The acids can be oxidizing or non-oxidizing acids, so long as the acid has the ability to dissolve metals. Typical acids include hydrochloric acid, and nitric acid. In the gas phase oxidation purification method, the SWNT are heated in the presence of gas that can oxidize carbon at high temperatures. This can selectively remove amorphous carbon from the SWNT. Typical gases include dry air, wet air, oxygen, and carbon dioxide. In the microwave heating method, the SWNT are exposed to microwave radiation in the presence of a gas that can oxidize carbon at high temperatures. The metal impurities become hot, causing oxidation of the surrounding carbon. This may be followed by the acid leaching method. In the field-flow fractionation method, the impure SWNT are suspended in water/surfactant or organic liquid. This method selectively filters large particles (SWNT) from small particles of metals using special filters and liquid flow patterns. In the size exclusion chromatography method, the SWNT are suspended in water/surfactant or organic liquid. This method selectively allows passage of large particles (SWNT, while small particles (metals) are trapped in the chromatography media. In the surfactant/water suspension method, the SWNT are suspended in water/surfactant mixtures. Centrifugation or other separation methods are used to separate high density impurities (metals) from the lower density SWNT. In the soluble polymer extraction method, the SWNT are mixed with soluble polymers in aqueous or organic solutions. The SWNT interact with the polymers, becoming suspended or dissolved in the liquid. Centrifugation or other separation methods are used to separate impurities (metals) from the soluble SWNT.

The purification processes that are described in Examples 1, 2, 4 and 5 utilize oxidizing acids and gaseous oxidants (I. W. Chiang et al, J. Phys. Chem. B., 2001, 105, 8297 and J.-M. Moon et al., J. Phys. Chem. B. 2001, 105, 5677), and remove most of these metallic residues and non-SWNT carbon, and other components by these treatments. Typically after purification, any remaining metals are covered with a layer of oxide or carbon (forming a carbon “onion”) and are thus expected in all likelihood to not be reactive with hydrogen. Although it may prove difficult to remove all traces of such H₂-reactive metal contaminants, the utility of the SWNT materials of this invention for hydrogen storage is not dependent on the presence of adventitious or added metal or metal alloy components.

After purification, it is preferred that the SWNT materials useful in this invention comprise less than 20 weight percent, or less than 10 weight percent or less than 5 weight percent impurities which include carbon in any form other than SWNT and metals.

The commonly used production methods for SWNT often yield closed SWNT that have a “cap” on one or both ends. These caps are formed from hemi-fullerene units that incorporate 5-and 6-membered rings similar to those found in the SWNT walls. It has been found that mild oxidation of the as-produced nanotubes can result in the opening of the nanotubes by a selective oxidation of the more-reactive caps (M. Green et al, Nature 1993, 362, 520). The SWNT, thus oxidized, now have accessible pores inside of the opened nanotubes (endohedral sites). SWNT with selectively oxidized caps are defined as opened SWNT. SWNT can also be opened by the action of mechanical cutting or exposure to high energy beams such as electron beams.

As produced, SWNT usually are long nanotubes and have a high aspect ratio (length/diameter) of >10³. These high aspect ratio SWNT can be “cut” by chemical (oxidative) or physical methods to produce shorter SWNT with a smaller aspect ratio. Such cut SWNT are anticipated to include ends that are not capped with hemi-fullerene units and thus considered to be opened as well as cut. Chemical cutting methods include fluorination and heat treatment of SWNT (Z. Gu et al, Nano Lett. 2002, 2, 1009), and probe ultrasonication in oxidizing acids (Dillon et al, Mat. Res. Soc. Symp. Proc., 2001, 633, Q9.11). The probe sonication method has the drawback of contaminating the cut SWNT with metal particles from the sonication probe. Physical cutting methods include grinding in the presence of solid dispersants (J. Chen et al, J. Am. Chem. Soc. 2001, 123, 6201), grinding in the presence of abrasive particles (I. Stepanek et al, Chem. Phys. Lett. 2000, 331, 125), and use of a homogenizer (M. Zhang et al, Chem. Phys. Lett. 2001, 349, 25). Preferred cutting methods to prepare SWNT for hydrogen storage do not add residual metal to the SWNT materials. The preferred cutting use mechanical grinding and or abrasion in the presence of simple solid and/or liquid grinding aids, such as surfactants.

As produced, SWNT materials of this invention typically comprise bundles of SWNT preferably having an average inter-nanotube spacing of from 0.3 to 0.4 nm. Having opened SWNT and cut SWNT increase the accessibility of the exohedral and endohedral adsorption sites. Alternative to cutting the nanotubes, increased accessibility to the exohedral and endohedral sites could be provided by defects and/or openings in the nanotube walls. In Mat. Res. Soc. Symp. Proc., 2001, 706, Z10.3.1, B. K. Pradhan et a/teach that aggressive oxidation with oxidizing acids can introduce “holes” and other sidewall defects in SWNT. Openings and defects in the SWNT would improve the hydrogen's access to the internal sites; however, too many defects and openings in the SWNT if they destroy the closely packed arrangement of the bundles of the SWNT may be harmful to the assembly's ability to absorb hydrogen.

In order to discern the range of nanotube diameters that would be most beneficial for H₂ storage, hydrogen adsorption isotherms were measured at different temperatures for nanotubes of different diameters as described in Examples 1, 2, 4 and 5. The H₂ adsorption isotherms are fully reversible and are indicative of a physical adsorption of hydrogen, defined here as a process where the hydrogen is adsorbed non-dissociatively, with retention of the H—H bond. From the isotherm data, hydrogen storage capacities and H₂ adsorption heats were calculated; results for the latter are collected in Table 1. The isosteric heat of adsorption can be derived using experimental adsorption isotherms determined at a minimum of two temperatures. As detailed by S. J. Gregg and K. S. W. Sing in “Adsorption, Surface Area and Porosity” second edition, Academic Press, 1982, p. 13-18, using isotherms at several temperatures, the relationship of equilbrium pressure and temperature at identical coverages can be plotted from the isotherms for a series of temperatures. For two temperatures, T. and T₂, and the corresponding equilibrium pressures p₁ and p₂, an amount of gas adsorbed nₐ (i.e. the gas “coverage”), the isosteric heat (q^{st}) can be calculated from the following equation:
q^{st}=[RT₁T₂/(T₂−T₁)](lnp₂−lnp₁)nₐ
where R=the gas constant.

The results of the isotherm experiments demonstrate a clear trend for hydrogen storage capacity and heat of adsorption as a function of SWNT diameter and aspect ratio (and length). Additionally, in Example 3, we have performed computational modeling of the adsorption of hydrogen on a number of discrete SWNT types, varying the diameter and chirality of the nanotube. These results have confirmed the established experimental trends of Examples 1, 2, 4 and 5.

The cited molecular dynamics (MD) quantum mechanical (QM) calculations of H. Cheng et al were performed only for 1.2 nm diameter armchair nanotubes. The desirable extension of these calculations to the many smaller required nanotube sizes and chiralties was considered to be too computationally demanding. An alternative, but just as informative computational methodology was developed specifically for providing a description of molecules in a curved carbon environment—as is the case with SWNT materials.

The methodology depends on our prior development of generalized atom-atom potential functions for H₂ in a curved carbon environment (Kostov, M. K.; Cheng, H.; Cooper, A. C.; Pez, G. P. Phys. Rev. Lett. 2002, 89, 6105). These functions are derived based on the existing force fields for interatomic potential functions for carbon atoms with sp² (trigonal planar) and sp³ (tetrahedral) atomic orbital hybridizations, which were developed using either experimental or high level, very precise ab initio quantum mechanics results.

Although this computational method is applicable to both bonding (i.e. as for C—H and C—C bonds) and non-bonding (e.g. weaker but significant C . . . H₂) interactions, the curvature effect at carbon has the most pronounced influence on the latter non-bonding (non-dissociative H₂ physisorption) interactions. Following convention, we describe the non-bonding forces with the Lennard-Jones (L-J) expression of the potential energy, V; where now, the L-J parameters, σ (which is the value of the interatomic distance where V=0) and ε (the potential well depth) are made explicitly dependent on the radius of the nanotube, r, using the following equations:

$$\begin{matrix}σ ( r ) = f ( r ) {σ}_{{sp}^{2}} + [ 1 - f ( r ) ] {σ}_{{sp}^{3}} & ( 1 ) \\ ɛ ( r ) = \{ \begin{matrix}f ( r ) {ɛ}_{{sp}^{2}} + [ 1 - f ( r ) ] {ɛ}_{{sp}^{3}}^{head \text{-} on} & exohedral \\ f ( r ) {ɛ}_{{sp}^{2}} - [ 1 - f ( r ) ] {ɛ}_{{sp}^{3}}^{side \text{-} on} & endohedral\end{matrix} & ( 2 )\end{matrix}$$

where

$$f ( r ) = {( 1 - \frac{{r}_{0}}{r} )}^{λ}$$

and r₀ is a reference constant, the radius of the smallest possible carbon nanotube. It is clear from Eqs. (1) and (2) that the non-bonding interactions in a nanotube with a large radius tend towards those for a graphene sheet, and that these interactive forces can be substantially enhanced for smaller radius nanotubes. This novel force field has allowed us to efficiently perform more extensive, and therefore highly instructive, calculations: the study of H₂/SWNT systems that include a large number of atoms (˜1,000-100,000) in the unit cell with a desirably longer time scale for more precise molecular dynamics simulations.

A more detailed description of the performed calculations is provided as part of Example 3. The predicted H₂ adsorption energy (−ΔE), and the distribution ratio of H₂ molecules between the nanotube interior (endohedral) to nanotube exterior (exohedral) sites at three representative levels of H₂ loading as a function of the nanotube diameter are summarized in Table 2.

The combined experimental and computational studies, as collected in Tables 1 and 2 show that SWNT bundles that are made up of smaller diameter nanotubes have enhanced heats of H₂ adsorption and are thus preferred as materials for the storage of hydrogen. Preferred for hydrogen adsorption are assemblies comprising bundles of small-diameter SWNT wherein a majority of the SWNT have a diameter less than or equal to 1.0 nm, or less than or equal to 0.8 nm, or from 0.4 to 0.8 nm. Alternatively, greater than 75% or greater than 90% of the SWNT have a diameter less than or equal to 1.0 nm, or less than or equal to 0.8 nm, or from 0.4 to 0.8 nm.

Additionally, it is demonstrated that SWNT arrays comprised of nanotubes of a low aspect ratio are preferred for the storage of hydrogen due to a more effective utilization of the very small pores that are found in bundles of small-diameter SWNT, thus providing both the access and the required H₂-sorbent interaction energy. More preferred for hydrogen adsorption are arrays of small-diameter SWNT with a average length less than or equal to 1000 nm or less than or equal to 500 nm or less than or equal to 200 nm.

Materials comprising the small-diameter SWNT of this invention are useful for the reversible storage of hydrogen. A specific process for reversibly storing and releasing hydrogen incorporates a suitable storage vessel containing the SWNT materials of this invention. The materials preferably comprise a plurality of bundles of SWNT. The vessel would likely be a metal (stainless steel, titanium, etc.) pressure vessel, tank or other container, referred to herein as vessel. The vessel could also be constructed of carbon fiber or a combination of metal and carbon fiber. The SWNT would be packed inside the vessel as a powder, pellets, or extrudates. Ideally, the SWNT would be packed in such a fashion to maximize the amount of SWNT that can fit into the vessel while at the same time providing an access for H₂ to the nanotube bundles. The packing density of the single wall carbon nanotubes in the vessel could be 0.7 to 2 grams/cubic centimeter or 1 to 2 grams/cubic centimeter or 1.2 to 2 grams/cubic centimeter. The vessel could have nominal “headspace” therein to allow for gas to enter/exit the vessel. The vessel may include internal mechanisms for transferring heat into and out of the vessel and the SWNT materials within the vessel. These could be “fins” or metal inserts that contact the outer walls of the vessel. There could be active temperature control of the vessel (ie. heating and cooling elements inside of the vessel). The vessel may include a valve to shut off the gas flow if necessary. The vessel could also contain a pressure regulator to control the pressure inside of the vessel.

The vessel is designed to facilitate heat transfer to and from the SWNT materials. The temperature of the vessel can be controlled by the use of standard cooling (e.g. refrigeration) and heating (e.g. resistive electrical or use of heat transfer media) processes. The SWNT material in the vessel and/or the vessel may need to be cooled during charging to dissipate the heat generated by the SWNT material during the exothermic adsorption process. Conversely, the SWNT material in the vessel and/or the vessel may need to be heated during the discharge process to contribute the thermal energy necessary to offset the endothermic desorption of hydrogen from the SWNT material. These cooling and heating steps during charging and discharging may be used to maintain a constant temperature in a pressure only process. (Cooling may mean removal of heat while maintaining an approximately constant or controlled temperature. Alternatively, cooling may mean removal of heat with a decrease of temperature.) Alternatively, in a combined pressure and temperature process, the cooling and heating steps may be used to decrease the temperature during charging or increase the temperature during discharging to provide for increased adsorption of hydrogen, and increased discharging of hydrogen, during the charging and discharging steps, respectively. Alternatively, in a temperature swing process, the charging step is performed while (by) cooling the SWNT materials, and the discharging step is performed while (by) heating the SWNT materials.

The SWNT material may be activated for hydrogen adsorption by heating under vacuum or in an inert gas flow. Then, hydrogen is admitted to the storage vessel until a desired equilibrium pressure of gaseous hydrogen is established. The source for the hydrogen that is charged into the vessel of this invention can be any source, including a large storage tank preferably with a flexible line having an on-off valve connected to the storage tank. The flexible line has a nozzle that is sized to fit into a port in the vessel and has means such as a gasket to form a seal between the nozzle and the port. Additionally, either the storage tank is at a pressure higher than the pressure in the vessel or the flexible line has a pressurization means, e.g. a mechanical compressor, to deliver the hydrogen at a higher pressure than the pressure in the vessel.

This invention additionally provides processes for the storage of hydrogen comprising the steps of providing a vessel comprising an assembly of single wall carbon nanotubes of this invention wherein the majority of the diameters of the individual nanotubes of the assembly range from 0.4 to 1.0 nanometers (nm); and introducing hydrogen into the vessel while increasing the pressure to a sorption pressure and/or introducing hydrogen into the vessel while decreasing the temperature to a sorption temperature. The single wall carbon nanotubes used in the processes are reversible physical adsorbents for hydrogen in pressure-swing, temperature-swing or combined pressure and temperature swing processes that may be associated with a particular range of H₂ adsorption heats (or enthalpies). Additionally the single wall carbon nanotubes may have a average length less than or equal to 1000 nm. The hydrogen is adsorbed by physical adsorption in these processes. Physical adsorption is defined here as a process where the hydrogen is adsorbed non-dissociatively (i.e. as intact H₂ molecules).

This invention additionally provides the process for storing hydrogen using a material comprising single wall carbon nanotubes as a reversible physical adsorbent for hydrogen in (a) a H₂-pressure-swing, (b) temperature-swing and (c) combined temperature and H₂-pressure swing processes that are associated with hydrogen sorption heats or enthalpies (−ΔH) that range from 4 kcal/mole H₂ to 8 kcal/mole H₂, or from 5 kcal/mole H₂ to 7.5 kcal/mole H₂, or from 5.3 or 6 kcal/mole H₂ to 7 kcal/mole H₂. As a brief illustration of the combined temperature and pressure swing process [which is commonly employed for gas separations as described for example by D. M. Ruthven in “Principles of Adsorption and Adsorption Processes”, John Wiley Publ. p. 338 (1998)], the material comprising SWNT is contained in a pressure vessel that is subjected to an elevated storage pressure (a sorption pressure) of, for example, 50 atm hydrogen resulting in an adsorption of the gas. Simply releasing the hydrogen to the required delivery pressure (a desorption pressure) of for example, 3 atm without changing the temperature for example maintaining it at a temperature of for example 20° C. [as in the pressure-swing process (a)] would result in a continued retention of the gas that is in equilibrium with the material at or below 3 atm, thus reducing the deliverable hydrogen storage capacity. However, by heating the vessel and/or the SWNT in the vessel, for example to 80° C. (desorption temperature), the H₂ capacity of the SWNT at 3 atm at 80° C. is less, and therefore, more of the once stored hydrogen can be delivered. The sorption and desorption pressures referred to herein are the pressures of the hydrogen that has been introduced into the vessel and may be the partial pressure of hydrogen if other components are present in the feed stream comprising hydrogen that is introduced into the vessel.

Typically, the contact time during the charging of the vessel (introducing hydrogen) of the material of the invention with the H₂ gas while achieving equilibrium will be from 0.5-120 minutes, although shorter or longer contact times may be desired depending upon the particular composition and specific reaction conditions used (temperature and pressure and vessel geometry). Generally, under these conditions it may be expected that the SWNT composition will store between 0.1 and 10 wt. % hydrogen for an indefinite period of time under or near the equilibrium partial pressure of hydrogen.

The charging step is performed by introducing hydrogen into a vessel while increasing the pressure from a lower pressure to a higher sorption pressure. A controlled discharge of the hydrogen from the vessel can be accomplished by lowering the equilibrium pressure of gaseous hydrogen in the vessel from a sorption pressure to a lower pressure. The lower pressure is a desorption pressure. The decreased pressure may be reached in a single continuous step while discharging the hydrogen, or may be reached in multiple steps depending on the demand for the hydrogen stored in the vessel. The gaseous hydrogen from the vessel can be discharged to the end use point. In a pressure only process the temperature of the vessel and/or SWNT materials may be maintained at a constant temperature, which may be near-ambient temperature during charging and discharging of the vessel. Alternatively, the vessel and/or SWNT materials may be cooled during the charging and heating during the discharging, resulting in an increase of the pressure of gaseous hydrogen which may be fed to the end use point, or in some instances, the hydrogen may be discharged by a combination of lowering the pressure and increasing the temperature. Upon partial/complete discharge of the stored hydrogen, the SWNT materials may be recharged by admitting hydrogen to the storage vessel, with heating/cooling to maintain the vessel at a desired temperature, until the desired equilibrium pressure of gaseous hydrogen is reformed. Re-activation of the SWNT array compositions, by heating under vacuum or inert gas flow, can be performed as necessary to maintain optimum performance.

For example, in one embodiment for the pressure-swing process H₂ may be introduced or charged into the vessel containing the SWNT material at a sorption pressure in the range from 50 psia to 5000 psia of H₂ partial pressure, or from 100 psia to 1000 psia, and may be desorbed or discharged at the same temperature but at a lower pressure, e.g. a desorption pressure in the range from 1 psia to 200 psia, or in the range from 14 psia to 50 psia. The sorption pressure at which the hydrogen is adsorbed and stored by the material is higher than the desorption pressure at which some or all of the stored hydrogen is desorbed from the material. If desired to maintain the SWNT material housed in the vessel at a constant temperature, heat will need to be removed from the SWNT material by cooling, while the hydrogen is adsorbed by the SWNT material during charging and heat will need to be added to the SWNT material by heating while the hydrogen is desorbed from the SWNT material during discharging.

For the temperature-swing process the H₂ may be contacted with or introduced to the SWNT material at a sorption temperature in the range from 243 K to 353 K, preferably from 273 K to 323 K, and may be desorbed or discharged at the same pressure but at a higher temperature, a desorption temperature, in the range from 273 K to 473 K, preferably from 293 K to 363 K.

More preferred is the combined pressure-temperature swing process, for which the adsorption or charging may be at a H₂ partial pressure (a sorption pressure) in the range from 50 psia to 5000 psia, preferably from 100 psia to 1000 psia, and a temperature (a sorption temperature) in the range from 243 K to 353 K, preferably from 273 K to 323 K; with desorption or discharging of the H₂ from the material taking place at a H₂ partial pressure (a desorption pressure) within the range from 1 psia to 200 psia, preferably from 14 psia to 50 psia, and a temperature (a desorption temperature) in the range from 273 K to 473 K, preferably from 293 K to 363 K. Example 6 provides an illustration of this process. But there may be conditions where the desorption could occur at pressures which are the same or higher than those at which the gas was admitted, but only if the desorption temperature is also significantly higher than the sorption temperature. Likewise, desorption could take place at the same or at a lower temperature than that for sorption if the pressure is now significantly lower than that of the H₂ sorption. The most preferred conditions for this temperature-pressure swing process will be where the H₂ sorption takes place at a combination of higher pressures (sorption pressures) and lower temperatures (sorption temperature): for example, ranging from 200 psia to 1000 psia, and from 273 K to 323 K, with the subsequent H₂ recovery by desorption taking place at lower pressures (desorption pressures) and higher temperatures (desorption temperatures): for example, ranging from 14 psia to 50 psia, and from 323 K to 363 K.

It is desired to have an H₂ storage material where there is an adequate partition between H₂ in the gas phase where it is in equilibrium with the adsorbed hydrogen. Ideally this partition factor or equilibrium constant is desired to be of a magnitude, which corresponds to most of the H₂ being stored in the material. This partition factor, and the overall energy efficiency of the H₂ storage process, are a function of the heat (−ΔH) of hydrogen adsorption which desirably ranges from 4 kcal/mole H₂ to 8 kcal/mole H₂, or from 5.0 to 7.5 kcal/mole H₂, or from 5.3 to 7 kcal/mole H₂, or from 6 to 7 kcal/mole H₂.

These processes are all reversible, and are repeated by charging at the sorption temperature, or sorption pressure, or sorption temperature and sorption pressure, and discharging at the desorption temperature, or desorption pressure, or desorption temperature and desorption pressure, for temperature swing, pressure swing, and temperature and pressure swing processes, respectively. It is not required that the hydrogen stored in the vessel comprising the SWNT material be fully charged with the maximum amount of hydrogen possible or fully discharged of all of its stored hydrogen during every cycle of the process. Desorption and sorption temperatures and/or desorption and sorption pressures between the ranges specified may be useful for partial charging and partial discharging of the vessel.

This heat (−ΔH) of H₂ adsorption of the material of this invention may be approximated by the electronic energy of H₂ adsorption (−ΔE), which can be predicted, as shown by Example 3 using first principles-based molecular dynamics calculations. We have found from such calculations that surprisingly, this energy −ΔE is strongly dependent on the diameter (measured on the outer cross-section of the nanotubes) that compose an SWNT array. The SWNT diameter not only dictates the adsorptive space that is available for hydrogen but also the heat of adsorption, the H₂ (gas)/H₂ (adsorbed) partition constant and ultimately the hydrogen storage capacity.

The heat of adsorption of H₂, −ΔH is an important SWNT material design and hydrogen storage process parameter. Fundamentally the gravimetric hydrogen capacity, is linked to the heat (ΔH) and the entropy (ΔS) of H₂ sorption which determine the strength and extent of its binding to the material, and to the volumetric space per unit mass of material that is accessible to hydrogen capture. This is expressed quantitatively as follows: The material (S) and H₂ equilibrium is expressed by Equation 1:

$$\begin{matrix}S ( s ) + {H}_{2} ( g ) {⇄}^{K} S • {H}_{2} ( s ) \\ where K ( {atm}^{- 1} ) = \frac{[ S • {H}_{2} ]}{[ S ] {P}_{{H}_{2}}}\end{matrix} \qquad ( 1 )$$

The terms in square brackets represent the concentration (activity) of H₂-bound [S·H₂] and of unused or empty “sites” [S] of the material at a given pressure of hydrogen, P_{H}_{₂}.

The equilibrium constant K is related to the Gibbs free energy (ΔG), heat (ΔH), and entropy (ΔS) of sorption by the familiar thermodynamic relationship:
ΔG=−RTlnK=ΔH−TΔS (3)

It's assumed that the envisaged reversible H₂/material interaction can be represented by a simple Langmuir isotherm model, where the heat of sorption is independent of the extent of H₂ binding, i.e.:

$$[ S • {H}_{2} ] = \frac{K [ {S}_{T} ] {P}_{{H}_{2}}}{1 + {KP}_{{H}_{2}}} \qquad ( 4 )$$

where S_{T}=[S·H₂]+[S] represents the maximum gravimetric H₂ capacity of the material.

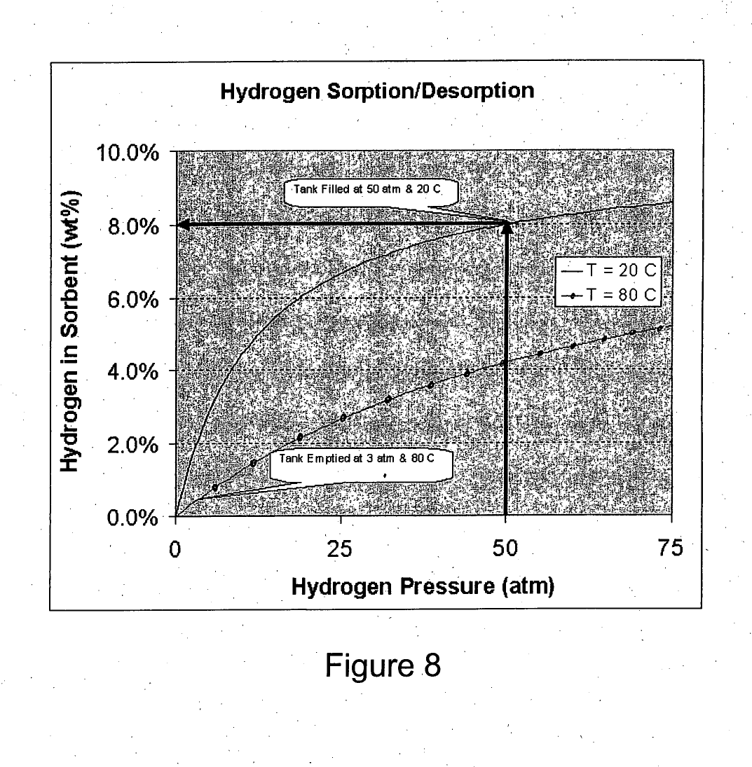

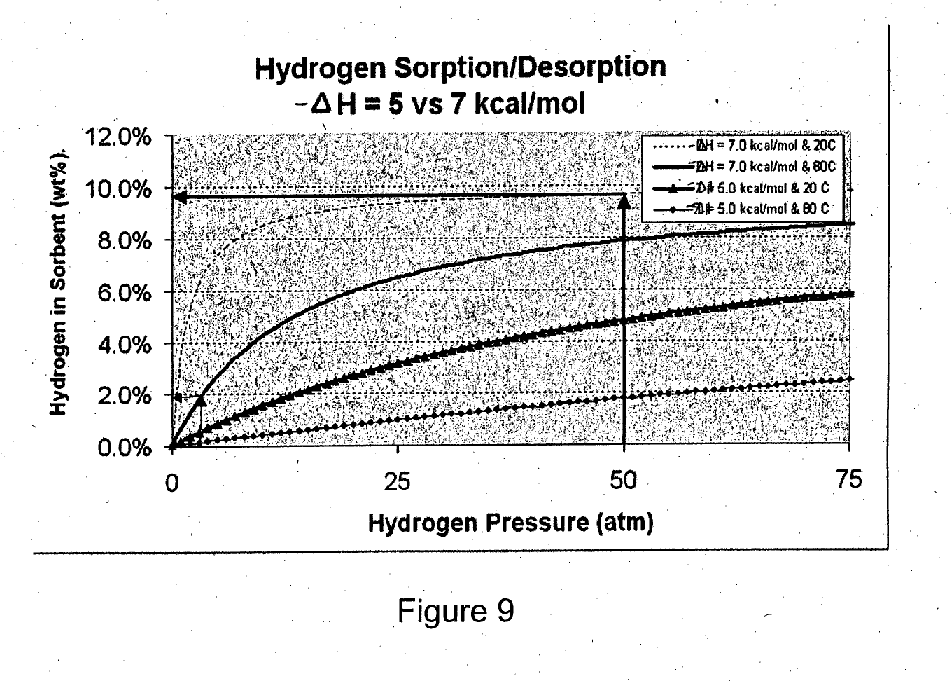

An illustration of this model (Equations 3 and 4) is provided in Example 6 and FIG. 8. A H₂/SWNT material for which ΔH is −5.9 kcal/mole H₂, ΔS=−25 cal/mole·K and S_{T} is 10 wt % in a pressure/temperature swing process can deliver 7.56 wt % hydrogen at these conditions. In contrast, in a pressure-swing process with desorption also at 20° C. only ˜6 wt % of the hydrogen is deliverable. As illustrated in FIG. 9 a larger (more negative) heat would result in steeper isotherms rendering more favorable the adsorption of gas but making its release more difficult. On the other hand a lower heat results in a lesser affinity for H₂ and the necessity of using higher pressure to obtain the 8 wt % H₂ loading. An H₂ adsorption process is accompanied by a loss of heat from the system (−ΔH) while a recovery of the adsorbed hydrogen requires at least the corresponding input of heat. Thus ΔH is also an important engineering design parameter since an H₂ adsorption/desorption process requires the practical means to transfer heat in and out of the system. In this respect a minimum ΔH is desirable but from Equations 3 and 4 it is evident that for a given ΔS, there needs to be a sufficiently high heat (−ΔH) for storage to take place at reasonable hydrogen pressures. In view of these material properties and engineering design considerations, a pressure-swing, temperature-swing and combined pressure/temperature-swing hydrogen storage process using SWNT materials will have an H₂ heat of adsorption (−ΔH) in the range from 4 kcal/mole H₂ to 8 kcal/mole H₂, or from 5.0 kcal/mole H₂ to 7.5 kcal/mole H₂, or from 5.3 or 6 and 7 kcal/mole H₂.

The following examples are presented to better illustrate the present invention and are not meant to be limiting.

### EXAMPLE 1

### Hydrogen Adsorption Isotherms and Derived Heats of Adsorption for Small-Diameter, Low-Aspect-Ratio Carbon Nanotube Array Materials

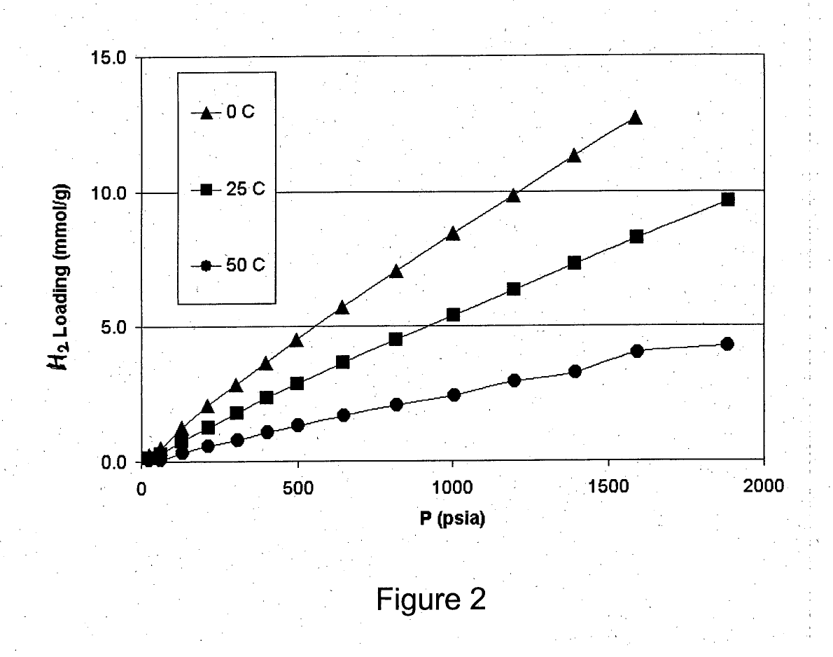

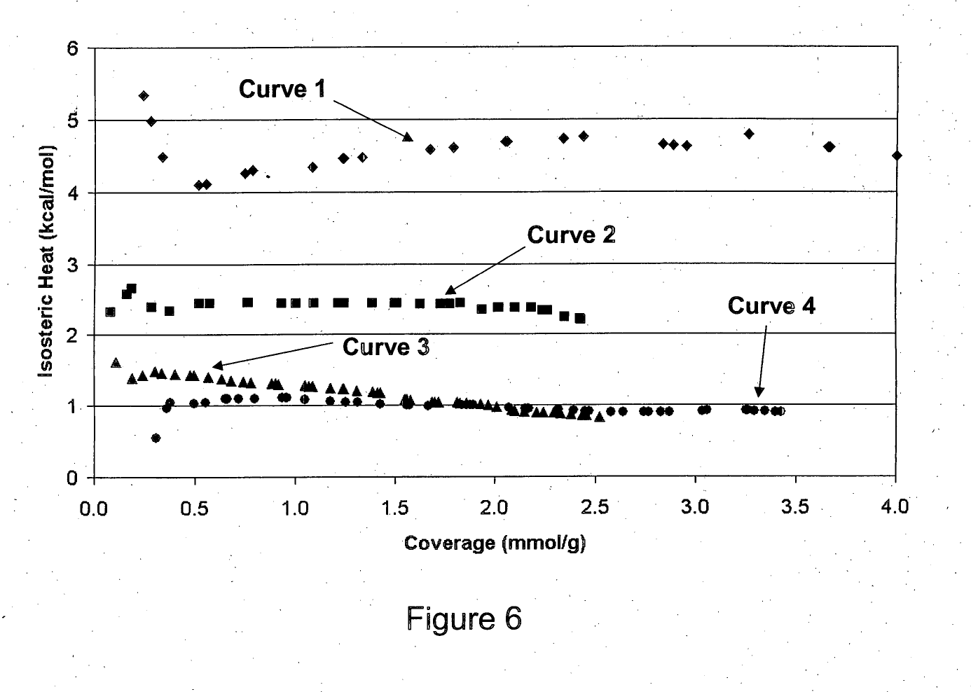

A sample of as-produced singlewalled carbon nanotubes (SWNT) was obtained from Carbon Nanotechnologies Inc. Thermogravimetric oxidation analysis determined that the as-produced SWNT contained ca. 28% (wt.) iron metal catalyst from the production process. The iron metal content was reduced to ca. 2% (wt.) using a modification of a published purification process (I. W. Chiang et al, J. Phys. Chem. B., 2001, 105, 8297). The purified SWNT material was subjected to a mechanical milling process that segments the SWNT into shorter lengths, using a process described in the literature by J. Chen et al (J. Am. Chem. Soc. 2001). Atomic force microscopy and laser light scattering data show the average SWNT length is 0.260 μm after milling. Raman spectroscopy analysis shows the distribution of SWNT diameters (Table 1), which are unaffected by the milling process. This material was degassed in a quartz cell at 873 K until a vacuum of 10⁻⁴ torr was achieved. The material was transferred under a purified argon atmosphere in a glovebox to a metal cell for adsorption analysis. The adsorption analysis was performed in a differential pressure adsorption unit (DPAU). This technique quantifies the adsorption of gases by measuring the pressure difference between a cell containing an adsorbent and an identical reference cell (D. J. Browning et al, Nano Lett. 2002, 2, 201). The sample and reference cells are maintained at an identical relative temperature throughout the analysis. This adsorption method has a pressure measurement accuracy of 0.02 psi independent of absolute pressure. This is 10-100 times more sensitive than conventional high pressure volumetric adsorption equipment and allows the accurate measurement of hydrogen adsorption even on small samples. The sample was degassed in the DPAU at 573 K under a vacuum of 10⁻⁴ torr before hydrogen adsorption analysis. Hydrogen isotherms were measured at several temperatures (0, 25, and 50° C.) at pressures up to 1800 psia (FIG. 2). The heat of adsorption (heat of adsorption at equal H₂ coverage's) was subsequently determined from the isotherm data (curve 1, FIG. 6).

### EXAMPLE 2

### Hydrogen Adsorption Isotherms and Derived Heats of Adsorption for Small-Diameter, High-Aspect-Ratio Carbon Nanotubes

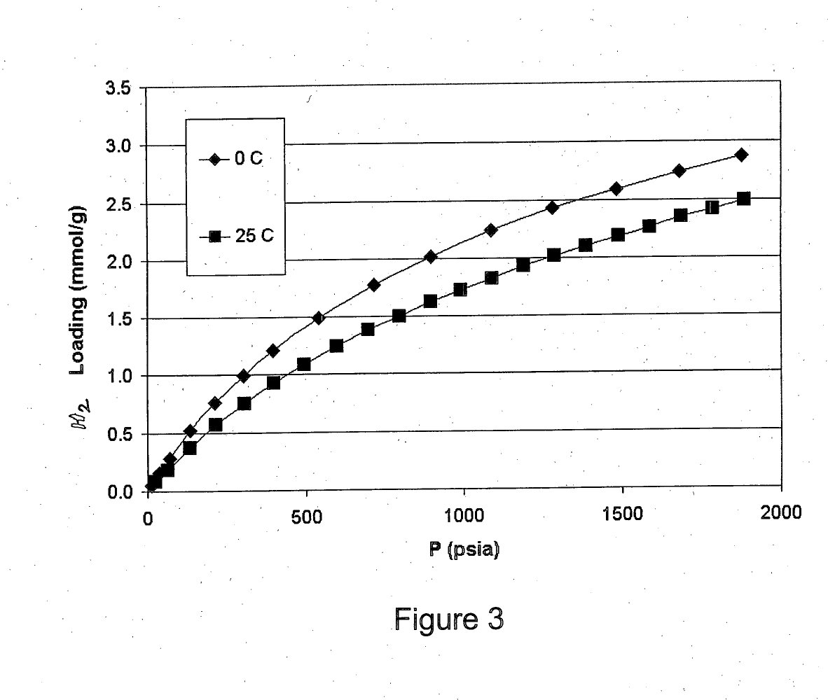

A sample of as-produced singlewalled carbon nanotubes (SWNT) was obtained from Carbon Nanotechnologies Inc. Thermogravimetric oxidation analysis determined that the as-produced SWNT contained ca. 28% (wt.) iron metal catalyst from the production process. The iron metal content was reduced to ca. 2% (wt.) using the same process used in Example 1. A mild oxidation of the purified SWNT sample was accomplished by heating the sample in flowing dry air at 300° C. for 2 hours. Atomic force microscopy and laser light scattering data show the average SWNT length is 6.7 μm. Raman spectroscopy analysis was used to determine the distribution of SWNT diameters (Table 1). This material was degassed in a quartz cell at 873 K until a vacuum of 10⁻⁴ torr was achieved. The material was transferred under a purified argon atmosphere in a glovebox to a metal cell for adsorption analysis. The adsorption analysis was performed in the DPAU as described in Example 1. The sample was degassed in the DPAU at 573 K under a vacuum of 10⁻⁴ torr before hydrogen adsorption analysis. Hydrogen isotherms were measured at two temperatures (0 and 25° C.) at pressures up to 1800 psia (FIG. 3). The heat of adsorption was determined from the isotherm data (curve 2, FIG. 6).

### EXAMPLE 3

### Constant-NVT Molecular Dynamics Simulations of SWNT Arrays and Hydrogen

Molecular dynamic (MD) simulations of hydrogen adsorption and storage in SWNT were performed using a model where the number of atoms (N), the volume (V) and the temperature (T) of the system are kept constant. In these calculations (as expressed by Equation 2), the interactions between H and C atoms for exohedral H₂ adsorption were treated differently than H—C interactions for endohedral H₂ adsorption thus accounting for the curvature effect which was ignored in prior such analyses. The MD simulations were conducted with a constant-NVT canonical ensemble using the Nose thermostat for temperature control. For a given SWNT, a rectangular box imposed with the periodic boundary condition containing 1×2×10 primitive cells of the SWNT was used in the simulation for 100 picoseconds (ps). All simulations were done using the Verlet algorithm with a time step of 1 fentosecond, at room temperature. Long range interactions were treated with the particle-mesh Ewald method as implemented in the AIREBO program package. All systems were first structurally optimized with a 10 ps MD run at 0 degrees K and then equilibrated for 10 picoseconds, at 300K. The averaged total energy for each MD run is then utilized to arrive at the adsorption energy, ΔE_{ad} using Eq. (3).
ΔE_{ad}=E_{tube+H}_{₂}−E_{tube}−E_{H}_{₂} (5)

For the MD simulations of hydrogen adsorption in SWNT arrays, three armchair nanotubes with diameters ranging from 4 Å to 12 Å, three zigzag nanotubes with sizes similar to the armchair nanotubes and one additional chiral nanotube with a diameter of 8.28 Å were selected. The nanotubes were considered as constituting in a close packed array of hexagonal symmetry, consistent with x-ray diffraction experimental data for SWNT arrays. For a given SWNT and H₂ loading, a full structural relaxation before and after H₂ uptake was performed and, as expected, a certain degree of lattice dilation upon H₂ adsorption (<2%), depending on the H₂ loading, was observed. Simulations of total hydrogen uptakes of 0.4 wt. %, 3.0 wt. % and 6.5 wt. %, respectively, for each of the nanotubes included in our study were performed. In each case, the optimal H₂ distribution in the lattice, between the endohedral and exohedral sites that gives the lowest energy among the possible distributions was determined. The calculated optimal H₂ distributions and the corresponding H₂ adsorption energies for the seven model SWNT arrays, are shown in Table 2.

### COMPARATIVE EXAMPLE 4

### Hydrogen Adsorption Isotherms for Large-Diameter, High-Aspect-Ratio Carbon Nanotubes from an Arc-Discharge Source

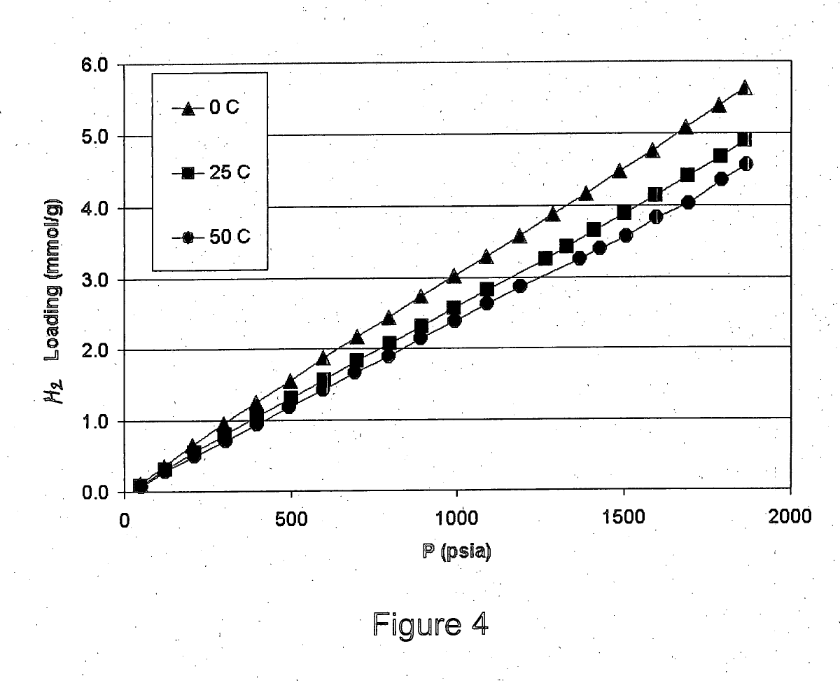

A sample of as-produced singlewalled carbon nanotubes (SWNT) was obtained from carbon arc-discharge source (Carbolex, Inc.). Thermogravimetric oxidation analysis determined that the as-produced SWNT contained 11% (wt.) metal catalyst and 30% (wt.) amorphous carbon from the production process. The amorphous carbon was eliminated and the metal content was reduced to 2% (wt.) using a modification of a published purification process (J.-M. Moon et al., J. Phys. Chem. B. 2001, 105, 5677). A mild oxidation of the purified SWNT sample was accomplished by heating the sample in flowing dry air at 350° C. for 3 hours. Scanning Electron Microscopy (SEM) and Transmission Electron Microscopy (TEM) analysis of the purified samples shows that the average SWNT length was >3 μm. Raman spectroscopy analysis was used to determine the distribution of SWNT diameters (Table 1). This material was degassed in a quartz cell at 873 K until a vacuum of 10⁻⁴ torr was achieved. The material was transferred under a purified argon atmosphere in a glovebox to a metal cell for adsorption analysis. The adsorption analysis was performed in the DPAU as described in Example 1. The sample was degassed in the DPAU at 573 K under a vacuum of 10⁻⁴ torr before hydrogen adsorption analysis. Hydrogen isotherms were measured at several temperatures (0, 25, and 50° C.) at pressures up to 1800 psia (FIG. 4). The heat of adsorption was determined from the isotherm data (curve 3, FIG. 6).

### COMPARATIVE EXAMPLE 5

### Hydrogen Adsorption Isotherms for Large-Diameter, High-Aspect-Ratio Carbon Nanotubes from Chemical Vapor Deposition Source

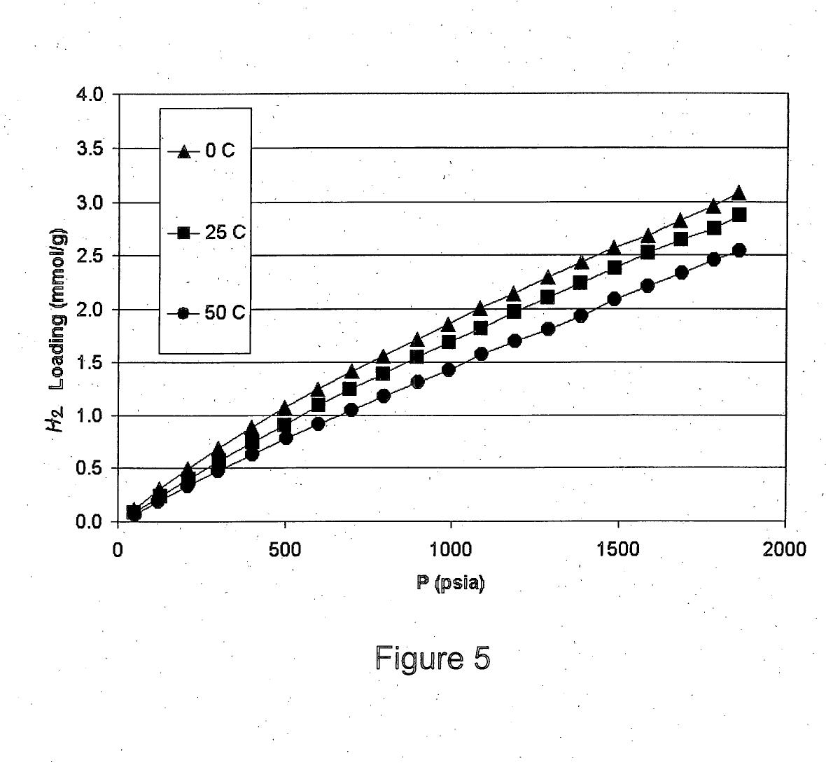

A sample of singlewalled carbon nanotubes (SWNT) was obtained from chemical vapor deposition using methane over a Fe/Mo catalyst on alumina. The metal and catalyst support was removed from the as-produced SWNT by treatment with concentrated aqueous hydrofluoric acid. Thermogravimetric oxidation analysis determined that the purified SWNT contained <2 wt. % metal and alumina. A mild oxidation of the purified SWNT sample was accomplished by heating the sample in flowing dry air at 350° C. for 4 hours. Scanning Electron Microscopy (SEM) and Transmission Electron Microscopy (TEM) analysis of the purified samples shows that the average SWNT length is >5 μm. Raman spectroscopy analysis was used to determine the distribution of SWNT diameters (Table 1). This material was degassed in a quartz cell at 873 K until a vacuum of 10⁻⁴ torr was achieved. The material was transferred under a purified argon atmosphere in a glovebox to a metal cell for adsorption analysis. The adsorption analysis was performed in a the DPAU as described in Example 1. The sample was degassed in the DPAU at 573 K under a vacuum of 10⁴ torr before hydrogen adsorption analysis. Hydrogen isotherms were measured at several temperatures (0, 25, and 50° C.) at pressures up to 1800 psia (FIG. 5). The heat of adsorption was determined from the isotherm data (curve 4, FIG. 6).

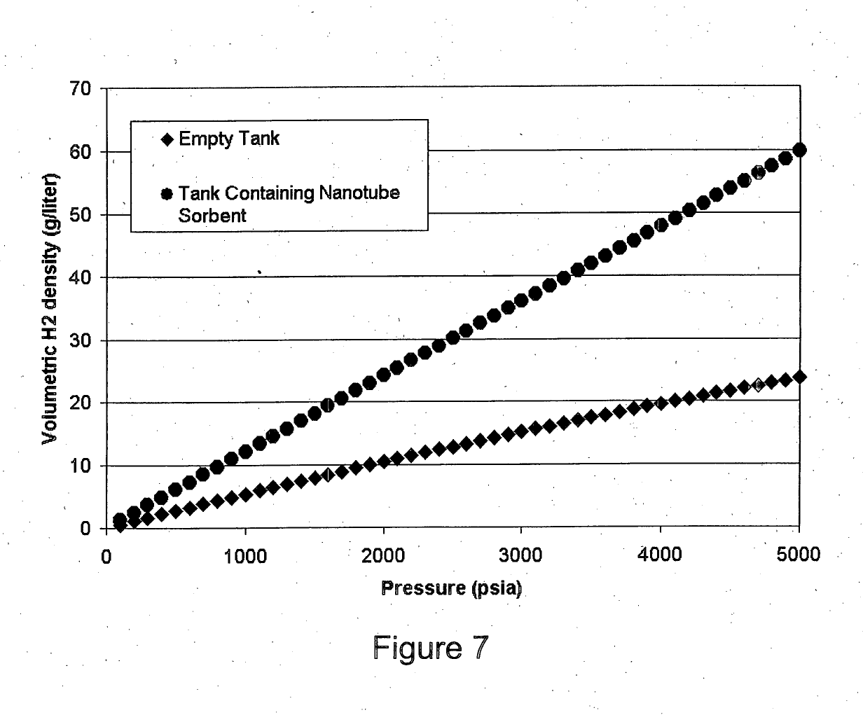

From FIG. 5 it is apparent that a H₂ capacity of ˜2 wt % is realized at 300 K and 1800 psi (ca. 120 atm). This is the “Gibbs excess” capacity, the amount of hydrogen that is contained in the system that is in excess of what would be there in the absence of the adsorbent material. Therefore, somewhat more H₂ could be contained by a vessel in the free space beyond the surface of the pores of the material. FIG. 7 provides an approximate estimate of this extra H₂ loading over the Gibbs excess adsorption. It shows that with an SWNT packing density of 1 g/cc, because of the Gibbs excess adsorption, significantly more total H₂ can be stored in the vessel than would be possible in the absence of the SWNT material, despite the free volume that the latter occupies.

### EXAMPLE 6

### Prospective Illustration of a Combined Pressure-Swing/Temperature Swing Process for Hydrogen Storage

A vessel that can withstand pressures of up to 100 atm and is equipped with the means of delivering a pressure-regulated supply of gas and a facility for heating and cooling the contents is loaded with 20 kg of a SWNT material of this invention. The contained adsorbent is degassed in situ by heating the vessel to 573-673 K while maintaining a dynamic vacuum of ˜10⁻⁴ torr. Hydrogen is then charged to the vessel at room temperature (293K), with accompanying cooling to take up the heat of adsorption and approximately maintain this temperature. The admission of H₂ is continued until an equilibrium pressure of 50 atm is reached. This corresponds to the upper isotherm curve of FIG. 8, which at this pressure corresponds to an 8 wt % total hydrogen capacity. The hydrogen may be delivered at a 3 atm (at 20° C.) delivery pressure to the point where this is now also the vessel's internal pressure. Here, in this “pressure-swing” process, only 6 wt % of the H₂ is actually deliverable. However, by now raising the temperature to 80° C.—following the lower isotherm curve of FIG. 8, most (7.56 wt % effective capacity) of the contained stored hydrogen is made available. The vessel loading with hydrogen will require the dissipation from the system of 5.9 kcal/mole H₂ of heat by use of an appropriate liquid coolant and a thermal input of at least the same magnitude for a delivery of the gas.

### Discussion of Examples

Experimental and computational examples have been used to demonstrate the effects of SWNT diameter and aspect ratio on the storage of hydrogen by these materials at near-ambient temperatures. The experimental data is collected in Table 1. Example 2 and comparative Examples 4 and 5 demonstrate that the thermodynamics of adsorption (ΔH and ΔS) greatly depend on the diameter of the carbon nanotubes. The three samples here of unsegmented SWNT bundles and arrays have similar average nanotube lengths (>3 μm) and purities (85-98%), but there is a substantial physical difference between them in terms of their diameter distribution. A heat of adsorption that is a factor of two higher is found for the SWNT sample in Example 2 which has a high concentration of relatively small diameter nanotubes (0.7-1.2 nm) relative to the samples of the Comparative Examples.

This nanotube diameter effect is consistent with and can also be rationalized by the computational modeling studies which were performed, the results for which are collected in Table 2. Hydrogen adsorption becomes increasingly favorable at the exohedral sites, at the interstial space between the nanotubes as the nanotube diameter decreases. For a perfect bundle of nanotubes with a diameter of approximately 0.4 nm, adsorption occurs exclusively at the exohedral site, because endohedral adsorption would result in too close a contact between H₂ molecules and the nanotube wall thus resulting in a strong repulsion. At low hydrogen loadings for SWNT of this invention, the molecular adsorption is favored at the exohedral site. Most importantly, the adsorption energy increases as the nanotube diameter decreases, indicating that smaller diameter carbon nanotube SWNT arrays are capable of adsorbing more hydrogen at ambient temperature than the larger nanotubes. This is consistent with the fact that the curvature of small nanotubes is greater and thus the hybridization or mixing of s and p atomic orbitals at carbon is more toward an sp³ or bent carbon configuration vis-á-vis an sp² planar configuration, (as in graphite). In the “toward sp³” configuration there are still only three linkages to carbon and the remaining fourth orbital is available for a non-bonding but yet significant interaction with an H₂ molecule. The average adsorption energy diminishes as the H₂ loading increases. This reduction of adsorption energy with an increased population of H₂ molecules in the material is mainly attributed to repulsive forces between the H₂ molecules.

A comparison of experimental and calculated hydrogen capacities is not possible since in the MD simulation external pressure (which can only augment the capacity) is not accounted for. However, a meaningful comparison can be made between the computed ΔE's and the isoteric heats (ΔH's). Thus, for ˜0.8 nm, (10,0) nanotubes, a −ΔE of 4.8 kcal/mole H₂ (Table 2) is in reasonable agreement with a −ΔH of 4.7 kcal/mole H₂ (Table 1) for 0.7-1.2 diameter nanotubes.

The important conclusion of this section is that because of the same and parallel trend of increasing (−ΔH) and −ΔE_{ads} with diminishing nanotube diameters, SWNT arrays of smaller nanotube diameters, where the majority of nanotubes have a diameter less than 1.0 nm, and preferably less than 0.8 nm, are favored for hydrogen storage.

TABLE 1

| | | SWNT | Average | ΔH | ΔS |
|---|---|---|---|---|---|
| | SWNT | Diameter | length | (kcal/mol | (cal/mol · K), |
| | Purity | (nm) | (μm) | H₂) Range | 298 K |
| Example 1 | >95% | 0.7-1.2 | 0.26 | 5.3-4.1 | 26 |
| Example 2 | >95% | 0.7-1.2 | 6.7 | 2.6-2.2 | 21 |
| Comp. | >85% | 1.0-1.4 | >3 | 1.6-0.8 | 17 |
| Example 4 | | | | | |
| Comp. | >98% | 1.2-2.5 | >5 | 1.1-0.4 | 16 |
| Example 5 | | | | | |

Example 1 demonstrates that both the hydrogen capacity and heat of adsorption are affected by the average length of the SWNT individual nanotubes in the sample. The sample described in Example 1 was “cut” to provide a average length of 0.26,m. (The sample had a length of 6.7 μm before cutting as described in Example 2.) This “cut” SWNT sample of Example 1 displays a greatly enhanced hydrogen capacity (4× higher) and heat of adsorption (2× higher) relative to the unmodified SWNT sample in Example 2. Both samples have identical diameter distributions as determined by a comparison of their Raman spectra. Our hypothesis is that the cut SWNT sample allows a greater access for hydrogen to the adsorption sites of the SWNT lattice. A larger volume percentage of the high heats of adsorption sites (exohedral sites) are occupied in the cut sample of Example 1 vs. the sample, which was not cut (Example 2). The poor utilization of the adsorption sites in the uncut samples may be due to diffusion limitations (single-file diffusion) and/or blocking of these sites by impurities trapped in the SWNT lattice (amorphous carbon, metal particles, etc.). Existing or in anyway induced defects in the SWNT structure are expected to assist an access of H₂ to the adsorption sites of the SWNT material.

TABLE 2

| nanotube | SWNT | 0.4 wt. % H₂ loading | | 3.0 wt. % H₂ loading | | 6.5 wt. % H₂ loading | |
|---|---|---|---|---|---|---|---|
| (n, m) | diameter | endo/exo | −ΔE(ads) | endo/exo | ΔE(ads) | endo/exo | ΔE(ads) |
| indices | (Å) | ratio | (kcal/mole) | ratio | (kcal/mole) | ratio | (kcal/mole) |
| (3, 3) | 4.068 | 0:100 | 5.7 | 0:100 | 4.9 | 0:100 | 3.7 |
| (5, 5) | 6.780 | 0:100 | 5.1 | 20:80 | 2.4 | 30:70 | 1.7 |
| (9, 9) | 12.204 | 0:100 | 3.8 | 40:60 | 1.4 | 50:50 | 1.1 |
| (5, 0) | 3.914 | 0:100 | 5.3 | 0:100 | 5.1 | 0:100 | 2.8 |
| (10, 0) | 7.828 | 0:100 | 4.8 | 20:80 | 2.1 | 30:70 | 0.9 |
| (15, 0) | 11.743 | 0:100 | 3.3 | 30:70 | 1.1 | 50:50 | 0.6 |
| (8, 4) | 8.285 | 0:100 | 4.3 | 20:80 | 1.9 | 30:70 | 0.6 |

In summary, the invention provides for improved hydrogen storage materials and processes for their use therein. The materials are arrays of single wall nanotubes of a range of nanotube diameters and lengths or diameters of the nanotubes and specified heats of adsorption of hydrogen. The diameter of the individual nanotubes in a closely packed array is strongly related to the space that's available for the contained H₂ and the heat and energy of adsorption. Hydrogen storage processes using these materials are described where optimally this heat of adsorption is from 4 to 8 kcal/mole H₂.

This invention has been described with reference to particular embodiments. It is understood that the description is not meant to be limiting, and modifications to this invention can be made that would fall within the scope of the claims which follow.

Each and every reference sited in this document is incorporated in its entirety herein by reference.

1. A material for the storage of hydrogen comprising
single wall carbon nanotubes, wherein a majority of diameters of the single wall carbon nanotubes range from 0.4 to 1.0 nm, and the average length of the single wall carbon nanotubes is less than or equal to 1000 nm.

2. The material of claim 1 wherein the average length is less than or equal to 500 nm.

3. The material of claim 1 wherein the average length is less than or equal to 200 nm.

4. The material of claim 1 wherein the majority of the diameters of the single wall carbon nanotubes range from 0.4 to 0.8 nanometers.

5. The material of claim 4 wherein the average length is less than or equal to 500.

6. The material of claim 1 wherein greater than 75 percent of the diameters of the single wall carbon nanotubes range from 0.4 to 1.0 nanometers.

7. The material of claim 1 wherein greater than 75 percent of the diameters of the single wall carbon nanotubes range from 0.4 to 0.8 nanometers.

8. The material of claim 1 wherein the single wall carbon nanotubes are in a plurality of bundles.

9. The material of claim 8 wherein each bundle comprises at least 7 single wall carbon nanotubes.

10. The material of claim 8 wherein each bundle comprises at least 100 single wall carbon nanotubes.

11. The material of claim 8 wherein the distance between the single wall carbon nanotubes in the bundles is between from 0.3 to 0.4 nm.

12. The material of claim 1 wherein the heat (−ΔH) of hydrogen adsorption of the material is within the range from 4 kcal/mole H₂ to 8 kcal/mole H₂.

13. The material of claim 1 wherein the heat (−ΔH) of hydrogen adsorption of the material is within the range from 5 kcal/mole H₂ to 7.5 kcal/mole H₂.

14. The material of claim 1 wherein the heat (−ΔH) of hydrogen adsorption of the material is within the range from 5.3 kcal/mole H₂ to 7 kcal/mole H₂.

15. A process for the storage and release of hydrogen in a vessel comprising single wall carbon nanotubes wherein the majority of diameters of the single wall carbon nanotubes range from 0.4 to 1.0 nm, and the average length of the single wall carbon nanotubes is less than or equal to 1000 nm, wherein said process is selected from the group consisting of:
pressure swing adsorption, temperature swing adsorption or pressure and temperature swing adsorption.

16. A process for the storage and release of hydrogen comprising the steps of:
providing a vessel comprising single wall carbon nanotubes wherein the majority of the diameters of the single wall carbon nanotubes of the assembly range from 0.4 to 1.0 nm, and the average length of the single wall carbon nanotubes is less than or equal to 1000 nm;
introducing hydrogen into the vessel while increasing the pressure to a sorption pressure; and
discharging the hydrogen from the vessel by decreasing the pressure from the sorption pressure to a desorption pressure.

17. The process of claim 16 further comprising the steps of:
cooling the single wall carbon nanotubes to a sorption temperature while performing said introducing step; and
heating the single wall carbon nanotubes from a sorption temperature to a desorption temperature while performing said discharging step.

18. The process of claim 16 further comprising the steps of:
cooling the single wall carbon nanotubes while performing said introducing step.
heating the single wall carbon nanotubes while performing said discharging step.

19. The process of claim 16 wherein the desorption pressure is in the range from 1 to 200 psia, and sorption pressure is in the range from 50 to 5000 psia.

20. The process of claim 16 wherein the desorption pressure is in the range from 14 to 50 psia, and sorption pressure is in the range from 100 to 1000 psia.

21. The process of claim 17 wherein the desorption temperature is in the range from 273 to 473 K and the sorption temperature is in the range from 243 to 353 K.

22. The process of claim 17 wherein the desorption temperature is in the range from 293 to 363 K and the sorption temperature is in the range from 273 to 323 K.

23. The process of claim 17 wherein the desorption pressure is in the range from 14 to 50 psia, the sorption pressure is in the range from 200 to 1000 psia, the desorption temperature is in the range from 323 to 363 K, and the sorption temperature is in the range from 273 to 323 K.

24. A process for the storage and release of hydrogen comprising the steps of:
providing a vessel comprising single wall carbon nanotubes wherein the majority of the diameters of the single wall carbon nanotubes of the assembly range from 0.4 to 1.0 nm, and the average length of the single wall carbon nanotubes is less than or equal to 1000 nm;
introducing hydrogen into the vessel while decreasing the temperature to a sorption temperature, and
discharging the hydrogen from the vessel by increasing the temperature from the sorption temperature to a desorption temperature.

25. A material for the storage of hydrogen comprising
single wall carbon nanotubes, wherein a majority of diameters of the single wall carbon nanotubes range from 0.4 to 1.0 nm, and the heat (−ΔH) of hydrogen adsorption of the material is within the range from 4 kcal/mole H₂ to 8 kcal/mole H₂.

26. The material of claim 25 wherein the heat (−ΔH) of hydrogen adsorption of the material is within the range from 5 kcal/mole H₂ to 7.5 kcal/mole H₂.

27. The material of claim 25 the heat (−ΔH) of hydrogen adsorption of the material is within the range from 5.3 kcal/mole H₂ to 7 kcal/mole H₂.

28. The material of claim 26 wherein the average length is less than or equal to 500 nm.

29. The material of claim 27 wherein the average length is less than or equal to 200 nm.

30. The material of claim 25 wherein the majority of the diameters of the single wall carbon nanotubes range from 0.4 to 0.8 nanometers.

31. The material of claim 25 wherein greater than 75 percent of the diameters of the single wall carbon nanotubes range from 0.4 to 1.0 nanometers.

32. The material of claim 25 wherein greater than 75 percent of the diameters of the single wall carbon nanotubes range from 0.4 to 0.8 nanometers.

33. The material of claim 25 wherein the single wall carbon nanotubes are in a plurality of bundles.

34. The material of claim 33 wherein each bundle comprises at least 7 single wall carbon nanotubes.

35. The material of claim 33 wherein each bundle comprises at least 100 single wall carbon nanotubes.

36. The material of claim 33 wherein the distance between the single wall carbon nanotubes in the bundles is between from 0.3 to 0.4 nm.

37. A process for the storage and release of hydrogen in a vessel comprising single wall carbon nanotubes wherein the majority of the diameters of the single wall carbon nanotubes range from 0.4 to 1.0 nm, and the heat (−ΔH) of hydrogen adsorption of the single wall carbon nanotubes is within the range from 4 kcal/mole H₂ to 8 kcal/mole H₂, wherein said process is selected from the group consisting of:
pressure swing adsorption, temperature swing adsorption or pressure and temperature swing adsorption.

38. A process for the storage of hydrogen comprising the steps of:
providing a vessel comprising single wall carbon nanotubes wherein the majority of the diameters of the single wall carbon nanotubes of the assembly range from 0.4 to 1.0 nm, and the heat (−ΔH) of hydrogen adsorption of the single wall carbon nanotubes is within the range from 4 kcal/mole H₂ to 8 kcal/mole H₂;
introducing hydrogen into the vessel while increasing the pressure to a sorption pressure; and
discharging the hydrogen from the vessel by decreasing the pressure from the sorption pressure to a desorption pressure.

39. The process of claim 38 further comprising the steps of:
cooling the single wall carbon nanotubes to a sorption temperature while performing said introducing step; and
heating the single wall carbon nanotubes from the sorption temperature to a desorption temperature while performing said discharging step.

40. The process of claim 38 further comprising the steps of:
cooling the single wall carbon nanotubes while performing said introducing step.
heating the single wall carbon nanotubes while performing said discharging step.

41. The process of claim 38 wherein the desorption pressure is in the range from 1 to 200 psia, and sorption pressure is in the range from 50 to 5000 psia.

42. The process of claim 38 wherein the desorption pressure is in the range from 14 to 50 psia, and sorption pressure is in the range from 100 to 1000 psia.

43. The process of claim 39 wherein the desorption temperature is in the range from 273 to 473 K and the sorption temperature is in the range from 243 to 353 K.

44. The process of claim 39 wherein the desorption temperature is in the range from 293 to 363 K and the sorption temperature is in the range from 273 to 323 K.

45. The process of claim 39 wherein the desorption pressure is in the range from 14 to 50 psia, the sorption pressure is in the range from 200 to 1000 psia, the desorption temperature is in the range from 323 to 363 K, and the sorption temperature is in the range from 273 to 323 K.

46. The process of claim 38, wherein said single wall carbon nanotubes have an average length less than or equal to 1000 nm.

47. A process for the storage and release of hydrogen comprising the steps of:
providing a vessel housing single wall carbon nanotubes wherein the majority of the diameters of the individual nanotubes of the assembly range from 0.4 to 1.0 nm, and the heat (−ΔH) of hydrogen adsorption of the single wall carbon nanotubes is within the range from 4 kcal/mole H₂ to 8 kcal/mole H₂, and
introducing hydrogen into the vessel while decreasing the temperature to a sorption temperature, and
discharging the hydrogen from the vessel by decreasing the pressure from the sorption pressure to a desorption pressure.
